(19) United States
(12) Patent Application Publication
(10) Pub. No.: US 2012/0285572 A1
(43) Pub. Date: Nov. 15, 2012

(54) PIPE ARRANGEMENT

(76) Inventors: Klaus Rhein, Buedingen (DE); Michael Schieb, Puebla (MX)

(21) Appl. No.: 13/468,342

(22) Filed: May 10, 2012

(30) Foreign Application Priority Data
May 13, 2011 (DE) 20 2011 100 810.3

(51) Int. Cl. F16L 23/02; B29C 45/76; B29C 45/14

(52) U.S. Cl. 138/109; 264/279; 264/40.5

(57) ABSTRACT

A pipe arrangement with a pipe portion. A pipe flange is formed on the pipe portion. The pipe flange is produced from plastics material and is connected to a circumferential portion of the pipe portion.

### CROSS-REFERENCE TO RELATED APPLICATIONS

This application claims the priority of German utility application DE 20 2011 100 810.3, filed May 13, 2011, the entire contents of which are incorporated herein by reference.

### BACKGROUND OF THE INVENTION

The present invention relates to a pipe arrangement with a pipe portion, wherein a pipe flange is formed on the pipe portion.

It is known, in the fields of pipe connections, for pipe flanges to be formed on pipe portions by the pipe portion being upset or compressed axially, this resulting in a portion of relatively large diameter (pipe flange). This method of producing pipe flanges is known both for metal pipes and for plastics-material pipes. It is also known for pipe flanges to be produced as a result of the pipe diameter being widened. The disadvantage with this method of producing pipe flanges is that the pipe portions are weakened or subjected, in part, to preliminary damage by the deformation (“stress whitening”).

### BRIEF SUMMARY OF THE INVENTION

The object of the invention is therefore to specify an improved pipe arrangement.

The above object is achieved by a pipe arrangement with a pipe portion, wherein a pipe flange is formed on the pipe portion, wherein the pipe flange is produced from plastics material and is connected to a circumferential portion of the pipe portion.

Consequently, in the case of the pipe arrangement according to the invention, the pipe flange may be provided without the pipe portion itself having to be deformed. The pipe flange made of plastics material here is formed on the circumferential portion of the pipe portion or connected firmly thereto in some other way, for example by adhesive bonding.

This avoids the disadvantage of the pipe portion being weakened during production of the flange.

The object is thus achieved in full.

According to a particularly preferred embodiment, the pipe flange has a beaded portion extending around the circumferential portion of the pipe portion.

The beaded portion here extends radially beyond the circumferential portion of the pipe portion and may be used, for example, to establish a pipe connection.

In general terms, the beaded portion may have one or more beaded portions extending over partial circumferential portions of the pipe portion.

It is particularly preferred, however, if the beaded portion is of encircling design, that is to say extends over the entire circumferential portion of the pipe portion.

According to a further preferred embodiment, the pipe flange is formed from a plurality of layers located radially one above the other.

In the case of this embodiment, the pipe flange may be formed by layers being applied one after the other.

Furthermore, it is advantageous if the pipe flange has a further beaded portion, which is formed on a further pipe portion and is connected in a single piece to the beaded portion of the pipe portion.

In the case of this embodiment, the pipe flange can be used for connecting pipe portions which are aligned parallel to one another, in particular are aligned at a distance apart from one another, preferably in a direction trans-verse to a longitudinal direction of the pipe portions. This makes it possible to form a pipe arrangement from a plurality of individual pipe portions which are fixed in position in relation to one another by means of the pipe flange.

It is possible, in general terms, for the pipe flange to be produced beforehand as a separate component from plastics material and then to be connected firmly, for example by adhesive bonding, to the circumferential portion of the pipe portion.

It is particularly advantageous, however, if the pipe flange itself is produced from an adhesive.

In the case of this embodiment, suitable adhesives, in particular, are those which are solid, or remain solidified, during subsequent use of the pipe arrangement.

In order to apply the plastics material for forming the pipe flange, it is preferred if the adhesive is a hot-melt plastics material.

In the case of this embodiment, the adhesive can easily be applied in a hot state in which it is free-flowing or free-flowing to a limited extent. Such hot-melt plastics materials achieve a relatively high strength upon cooling, and this property makes them suitable as a pipe flange, or some other connecting element between pipe portions.

The adhesive property here establishes a firm connection between the circumferential portion of the pipe portion and the pipe flange.

It is particularly preferred if the plastics material is selected from one or more among the group of plastics materials containing polyamide, polyolefin and copolyester.

These plastics materials are suitable, in particular, for forming pipe flanges.

The pipe portion itself can be produced from a plastics material, but can also be produced from metal.

It is particularly preferred, furthermore, if the pipe portion has a circumferential groove, into which the pipe flange is inserted.

In the case of this embodiment, a kind of form fit can be established in the axial direction between the solidified pipe flange and the pipe portion, so that it is possible to achieve high axial retaining forces via the pipe flange.

The above invention is also achieved by a method of producing a pipe arrangement, in particular a pipe arrangement of the type described above, wherein the method has the steps of supplying a pipe portion and of applying a beaded portion made of a plastics material to a circumferential surface of the pipe portion such that the beaded portion forms a pipe flange.

The plastics material here is preferably a hot-melt adhesive of the type described above.

In the case of the method according to the invention, it is preferred if the beaded portion is applied by a relative movement between the pipe portion and a nozzle out of which the plastics material flows in the free-flowing state (for example supplied by an extruder).

A bead of the plastics material is applied here to the circumferential portion of the pipe portion and, when solidified, forms the beaded portion.

It is particularly preferred here if it is possible to adjust the radial distance between the nozzle and the pipe portion.

It is, for example, possible here to influence the radial height of the beaded portion.

It is particularly advantageous here if the height of the beaded portion applied by means of the nozzle is monitored by a sensor arrangement.

This makes it possible to form a circumferentially encircling beaded portion of uniform height throughout.

It is also preferred if the beaded portion is formed by a plurality of layers located radially one above the other.

In the case of this embodiment, the beaded portion may be formed, for example, by the relative movement between the pipe portion and the nozzle involving a number of revolutions around the circumferential portion of the pipe portion. It is possible here for a relatively thin bead of the plastics material to be applied in each case, the bead cooling relatively quickly and holding its shape from then on. Following one revolution around the circumferential portion, it is possible, once again, for a further relatively thin layer of the plastics material to be applied to the bead portion which has solidified in such a way, so that the beaded portion, ultimately, is formed by a plurality of layers located radially one upon the other.

The above method of applying a beaded portion can be realized by means of an apparatus of comparatively straightforward construction.

In order to achieve, in particular, defined shaping of the beaded portion, it is preferred, as an alternative, if the pipe portion is inserted into a mould and if the plastics material is introduced into a cavity of the mould which extends around the pipe portion.

This method of applying the beaded portion corresponds to a kind of injection-moulding method. The plastics material introduced into the cavity then remains in the cavity until it has solidified and has undergone firm connection to the pipe portion. The mould can then be opened again in order for the completed pipe arrangement to be removed.

It is particularly preferred here if a plurality of pipe portions are inserted into a mould and at least two cavities are connected to one another such that these pipe portions are connected to one another by the resulting overall pipe flange.

In the case of this embodiment, it is possible for pipe portions to be secured at a distance apart from one another by the overall pipe flange. The pipe portions here can run parallel to one another, but may also run at an angle to one another.

Consequently, the present invention preferably covers pipe arrangements with pipe flanges which are applied to circumferential portions of the pipe portions by injection moulding or extrusion. Moulds can be used to achieve a precise geometry for the pipe flanges.

Furthermore, it is comparatively straightforward to fit a plurality of pipe flanges on a pipe. This can take place, in the case of the extrusion method described above, by the pipe flanges being applied one after the other by means of a nozzle. If use is made of a mould, it is also possible for a plurality of flanges to be formed on the pipe portion simultaneously.

The plastics material for producing the pipe flanges can be applied without pressure, under low pressure or under high pressure. Application can take place either freely or by means of moulds. The connection between the pipe portion and the pipe flange may involve material bonding and/or a force fit, and, in the case of a groove being supplied on the pipe portion, also a form fit.

The pipe arrangements may be produced manually or in a partially or fully automated manner. One or more pipe flanges may be produced while operation is underway. It is also possible for a plurality of individual pipes to be processed simultaneously.

Pipe arrangements of the type described above are used, in particular, in automated engineering for conveying various media, e.g. in the form of fuel-channelling lines, air vent lines, brake vacuum lines, oil-channelling lines, charge air lines, etc. If the pipe portions used are produced from plastics material, these pipe arrangements are supplied usually in a prefabricated and/or thermoformed state.

The pipe flanges serve for the relatively straightforward installation of the pipes in holders provided for this purpose, or they serve as a stop in order for connection parts (hoses, etc.) to be mounted thereon. In addition, in the case of the pipe arrangements according to the invention, it is possible for the offset (for example in relation to an axial end of the pipe portion) and/or the contour of the pipe flange to be adjusted, and defined, within wide limits.

In the event of use being made of pipe portions made of plastics material, it is preferred if the pipe portions are completed or brought into their final shape beforehand by thermoforming. Since, in this case, the pipe flange is fitted following thermoforming, any undefined restoring behaviour can be avoided.

Of course, the features which have been mentioned above, and those which have yet to be explained hereinbelow, can be used not just in the given combination, but also in other combinations or on their own, without departing from the framework of the present invention.

### BRIEF DESCRIPTION OF THE SEVERAL VIEWS OF THE DRAWING

Exemplary embodiments of the invention will be explained in more detail in the following description and are illustrated in the drawing, in which:

FIG. 1 shows a longitudinal section through a pipe arrangement according to one embodiment of the invention;

FIG. 2 shows a sectional view taken along line II-II from FIG. 1;

FIG. 3 shows a longitudinal section through a further embodiment of a pipe arrangement according to the invention;

FIG. 4 shows a sectional view taken along line IV-IV from FIG. 3;

FIG. 5 shows an apparatus for producing a first embodiment of a pipe arrangement according to the invention;

FIG. 6 shows a sectional view through a further embodiment of an apparatus for producing a pipe arrangement according to the invention; and

FIG. 7 shows a side view of the apparatus from FIG. 6.

### DETAILED DESCRIPTION OF THE INVENTION

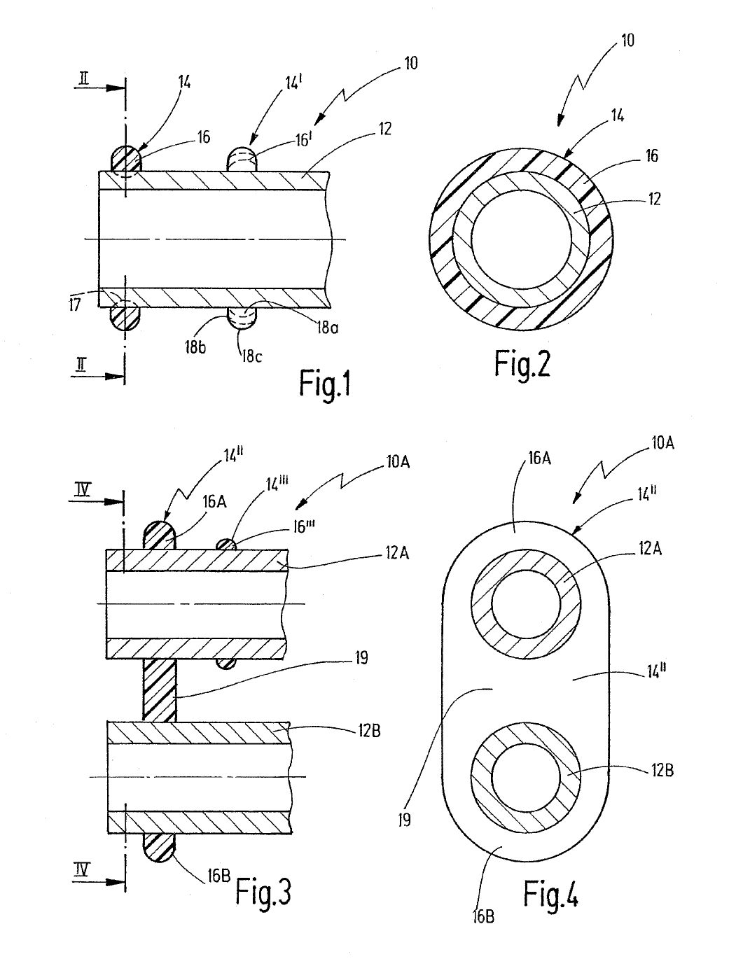

In FIGS. 1 and 2, a first embodiment of a pipe arrangement according to the invention is designated, in general terms, by 10.

The pipe arrangement 10 has a pipe portion 12, which has a pipe diameter which is uniform throughout in the axial direction. The pipe portion 12 may be produced from plastics material, for example from PA11, PA12, PA6, PA6.10 or from TPE. The pipe portion 12 can be produced from a single material throughout, but can also be formed as a multilayered pipe portion, wherein an outer layer is produced preferably from any of the materials mentioned above.

Furthermore, the pipe portion may be produced from steel, stainless steel or aluminium. It is also possible for the pipe portion 12 to be designed as a coated steel pipe or as a coated aluminium pipe, wherein the coating is produced preferably from PA.

The pipe arrangement 10 also has a pipe flange 14, which is formed around an outer circumferential portion of the pipe portion 12. The pipe flange 14 is produced from plastics material and is connected firmly, for example by adhesive bonding, to the outer circumferential portion of the pipe portion 12.

It is particularly preferred if the pipe flange 14 is produced from a hot-melt plastics material, in particular from polyamide, polyolefin or co polyester or from a combination of these plastics materials.

The pipe flange 14 is formed here by a beaded portion 16, which is designed as an encircling beaded portion and has been applied to the surface of the outer circumference by extrusion or injection moulding for example, to be precise in a liquid or viscous state. The geometry of the pipe flange 14 may be selected as desired and is illustrated in FIG. 1 as being approximately semicircular. However, the geometry may also be polygonal, in particular if the pipe flange 14 has been applied by injection moulding (see below).

FIG. 1 uses dashes to illustrate that the pipe portion 12 may have a circumferential groove 17 in the region where the pipe flange 14 is applied. In this case, the connection established in the axial direction between the pipe portion 12 and the pipe flange 14 involves not just material bonding and/or a force fit, but also a kind of form fit. The axial retaining forces of the pipe flange 14 can be increased as a result.

FIG. 1 also illustrates an optional further pipe flange 14′, which is formed from a beaded portion 16′. In the present case, the beaded portion 16′ comprises a plurality of layers 18a, 18b, 18c located radially one above the other. Such a beaded portion 16′ may be produced, for example, by extrusion, as will be described hereinbelow.

In FIGS. 3 and 4, a further embodiment of a pipe arrangement according to the invention is illustrated and designated, in general terms, by 10A. The pipe arrangement 10A corresponds in general terms, in respect of construction and functioning, to the pipe arrangement 10 from FIGS. 1 and 2. The same elements therefore have the same designations. It is essentially the differences which will be explained hereinbelow.

In the case of the embodiment of FIGS. 3 and 4, the pipe arrangement 10A has a first pipe portion 12A and a second pipe portion 12B, which are spaced apart from one another. The pipe arrangement 10A also has a pipe flange 14″, which is formed by a first beaded portion 16A, formed around the first pipe portion 12A, and by a second beaded portion 16B, formed around the second pipe portion 12B. The two beaded portions 16A, 16B are connected to one another via a connecting portion 19, which is formed in a single piece with the beaded portions 16A, 16B. Consequently, the two pipe portions 12A, 12B can be fixed relative to one another by the pipe flange 14″. The embodiment of FIGS. 3 and 4 is produced preferably by injection moulding, as will be described hereinbelow.

FIG. 3 also shows that it is possible to provide a plurality of pipe flanges on a pipe portion (for example pipe portion 12A), for example to provide a further pipe flange 14′″ alongside the pipe flange 14″, this further pipe flange 14′″ being formed, for example, merely as beaded portion 16′″ around the first pipe portion 12A.

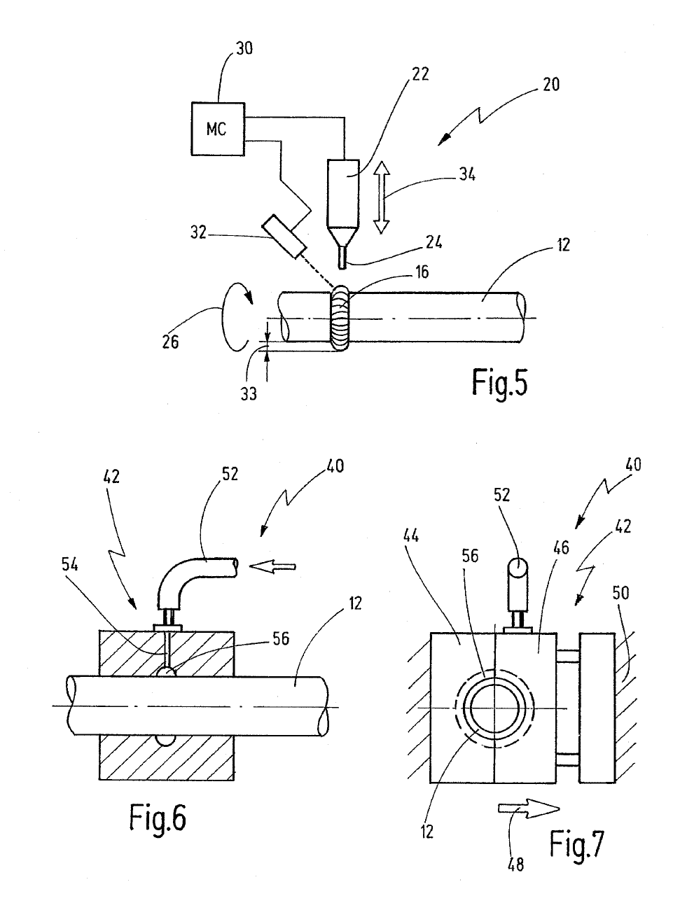

In FIG. 5, a first apparatus for producing a pipe arrangement according to the invention is shown and designated, in general terms, by 20.

The production apparatus 20 has an application device 22, which is illustrated schematically in FIG. 5 and contains, for example, an extruder for supplying a viscous plastics mass. The application device 22 also contains a nozzle 24, via which the viscous plastics material or adhesive can be discharged. A pipe portion 12 supplied is mounted such that it can be rotated, in the production apparatus 20, about its longitudinal axis, as is shown at 26. As an alternative, it is provided that the nozzle 24 is rotated around the pipe portion 12.

The production apparatus 20 also contains a control device 30, which activates the application device 22. Co-ordinated discharge of the plastics material from the application device 22 and rotation of the pipe portion 12 make it possible for a flange bead in the form of a beaded portion 16 to be applied around the outer circumference of the pipe portion 12. It should be ensured here that the plastics material is of sufficient viscosity essentially to maintain its shape until it has solidified again by cooling.

The production apparatus 20 also preferably has a sensor arrangement 32, which is designed to sense the height 33 and/or a width of the beaded portion 16. The sensor arrangement 32 is connected to the control device 30. It is thus possible to monitor the shape, in particular the height 33, of the beaded portion 16. It is also possible, preferably in dependence on a signal from the sensor arrangement 32, to regulate the rotary speed of the pipe portion 12. At 34, furthermore, it is shown that at least the nozzle 24 of the application device 22 can be moved in a radial direction relative to the pipe portion 12. In the case of this embodiment, the shape of the beaded portion 16 can be influenced, if appropriate, by virtue of the height being changed.

It is particularly preferred, however, if the beaded portion 16 is formed by a plurality of layers, as is shown in FIG. 1 at 18a to 18c. In this case, rather than being formed by a single revolution of the pipe portion 12, the beaded portion 16 is formed during a number of revolutions of the pipe portion 12. It is possible here to apply in each case just a relatively thin bead, which can solidify relatively quickly by cooling. In particular, it is possible for the first-applied part of the bead already to be solidified following one revolution of the pipe portion 12, so that the next layer (for example 18b) can then be applied over it, etc. This measure allows the height 33 of the beaded portion 16 to be very precisely monitored and adjusted.

Of course, the nozzle 24 can be moved further away from the circumference of the pipe portion 12, in direction 34, for each individual layer.

A further embodiment of a production apparatus, as is illustrated in FIGS. 6 and 7, is suitable for producing pipe arrangements according to the invention with a pipe flange 14 which has a defined geometry.

The production apparatus 40 of FIGS. 6 and 7 is designed as an injection mould and has a first mould half 44 and a second mould half 46, which are shown in a closed state in FIG. 7 and can be opened out of this closed state in an opening direction 48.

For this purpose, for example the second mould half 46 is designed such that it can be moved relative to a housing 50 of the production apparatus 40, as is indicated in FIG. 7.

In the closed state, the mould halves 44, 46 form a cylinder cavity for accommodating the pipe portion 12, wherein the region where a pipe flange 14 is to be accommodated contains a pipe-flange cavity 56, which is formed as an annular cavity around the pipe portion 12. The cavity 56 is connected via an introduction channel 54 to a feed tube 52 for feeding free-flowing plastics material.

In order to produce a pipe arrangement according to the invention, the mould halves 44, 46 are opened. A pipe portion 12 is then introduced. After this, the mould halves 44, 46 are closed and plastics material is injected into the cavity 56. A period of time is then allowed until the plastics material is dimensionally stable and/or has hardened. The mould halves 44, 46 are subsequently opened again and the completed pipe arrangement can be removed.

It is possible for a plurality of cavities 56 to be provided in a production apparatus 40 of the type shown in FIGS. 6 and 7, in order for a plurality of pipe flanges to be provided axially one behind the other on a single pipe portion 12. According to a further preferred embodiment, an alternative embodiment of such a production apparatus has mounts for two or more pipe portions, wherein a cavity 56 for the plastics material is formed by annular cavities for the respective pipe portions with at least two connected to one another. This makes it possible to produce a pipe arrangement 10A of the type shown in FIGS. 3 and 4.

What is claimed is:

1. A pipe arrangement with a pipe portion and a pipe flange formed on the pipe portion,
wherein the pipe flange is produced from plastics material independent of the pipe portion and is permanently connected to a circumferential portion of the pipe portion.

2. The pipe arrangement according to claim 1, wherein the pipe flange has a beaded portion extending around the circumferential portion of the pipe portion.

3. The pipe arrangement according to claim 2, wherein the beaded portion is of encircling design.

4. The pipe arrangement according to claim 1, wherein the pipe flange is formed from a plurality of layers located radially one above the other.

5. The pipe arrangement according to claim 2, wherein the pipe flange has a further beaded portion, which is formed on a further pipe portion and is connected in a single piece to the beaded portion of the pipe portion.

6. The pipe arrangement according to claim 1, wherein the pipe flange is produced from an adhesive.

7. The pipe arrangement according to claim 6, wherein the adhesive is a hot-melt plastics material.

8. The pipe arrangement according to claim 6, wherein the plastics material is selected from one or more among the group of plastics materials containing polyamide, polyolefin and copolyester.

9. The pipe arrangement according to claim 1, wherein the pipe portion is produced from plastics material.

10. The pipe arrangement according to claim 1, wherein the pipe portion is produced from metal.

11. The pipe arrangement according to claim 1, wherein the pipe portion has a circumferential groove, into which the pipe flange is inserted.

12. A method of producing a pipe arrangement, having the following steps:
supplying a pipe portion;
applying a beaded portion made of a plastics material to a circumferential surface of the pipe portion such that the beaded portion forms a pipe flange.

13. The method according to claim 12, wherein the beaded portion is applied by relative movement between the pipe portion and a nozzle out of which the plastics material flows in the free-flowing state.

14. The method according to claim 13, wherein it is possible to adjust the radial distance between the nozzle and the pipe portion.

15. The method according to claim 13, wherein the height of the beaded portion applied by means of the nozzle is monitored by means of a sensor arrangement.

16. The method according to claims 11, wherein the beaded portion is formed by a plurality of layers located radially one above the other.

17. The method according to claim 11, wherein the pipe portion is inserted into a mould and the plastics material is introduced into a cavity of the mould which extends around the pipe portion.

18. The method according to claim 17, wherein a plurality of pipe portions are inserted into a mould and at least two cavities are connected to one another such that the pipe portions are connected to one another by the resulting overall pipe flange.

19. A pipe arrangement with a pipe portion, wherein a pipe flange is formed on the pipe portion, wherein the pipe flange is produced from plastics material independent of the pipe portion and is connected to a circumferential portion of the pipe portion, wherein the pipe flange has a beaded portion extending around the circumferential portion of the pipe portion, wherein the beaded portion is of encircling design, and wherein the pipe flange is formed from a plurality of layers located radially one above the other.

20. The pipe arrangement according to claim 19, wherein the pipe flange is produced from an adhesive.

21. The pipe arrangement according to claim 20, wherein the pipe portion has a circumferential groove, into which the pipe flange is inserted.

22. A method of producing a pipe arrangement, having the following steps:
supplying a pipe portion;
applying a beaded portion made of a plastics material to a circumferential surface of the pipe portion such that the beaded portion forms a pipe flange, wherein the beaded portion is applied by relative movement between the pipe portion and a nozzle out of which the plastics material flows in the free-flowing state, wherein it is possible to adjust the radial distance between the nozzle and the pipe portion, and wherein the beaded portion is formed by a plurality of layers being applied one after the other so that they are located radially one above the other.

23. The method according to claim 22, wherein the height of the applied layers and of the beaded portion is monitored by means of a sensor arrangement.

24. A method of producing a pipe arrangement, having the following steps:
supplying at least two pipe portions;
applying a beaded portion made of a plastics material to a circumferential surface of the pipe portion such that the beaded portion forms a pipe flange, wherein the pipe portions are inserted into a mould and the plastics material is introduced into a cavity of the mould which extends around the pipe portions, such that the pipe portions are connected to one another by the resulting overall pipe flange.
